(19) United States
(12) Patent Application Publication
(10) Pub. No.: US 2005/0088633 A1
(43) Pub. Date: Apr. 28, 2005

(54) Composite optical lithography method for patterning lines of unequal width

(75) Inventor: Yan Borodovsky, Portland, OR (US)

Correspondence Address: FISH & RICHARDSON, PC, 12390 EL CAMINO REAL, SAN DIEGO, CA, 92130-2081, US

(73) Assignee: Intel Corporation

(21) Appl. No.: 10/693,373

(22) Filed: Oct. 24, 2003

(51) Int. Cl. G03B 27/00

(52) U.S. Cl. 355/18; 430/322; 355/77

(57) ABSTRACT

A composite patterning technique may include two lithography processes. A first lithography process may use interference lithography to form an interference pattern of lines of substantially equal width and spaces on a photoresist. A second lithography process may use one or more non-interference lithography techniques, such as optical lithography, imprint lithography and electron-beam lithography, to break continuity of the patterned lines and form desired integrated circuit features.

### BACKGROUND

An integrated circuit (IC) manufacturing process may deposit various material layers on a wafer and form a photosensitive resist (photoresist) on the deposited layers. The process may use lithography to transmit light through or reflect light from a patterned reticle (mask) to the photoresist. Light from the reticle transfers a patterned image onto the photoresist. The process may remove portions of the photoresist which are exposed to light. A process may etch portions of the wafer which are not protected by the remaining photoresist to form integrated circuit features.

The semiconductor industry may continually strive to reduce the size of transistor features to increase transistor density and to improve transistor performance. This desire has driven a reduction in the wavelength of light used in photolithographic techniques to define smaller IC features in a photoresist. Complex lithographic exposure tools may cost more to make and operate.

A conventional patterning technique may use expensive, diffraction-limited, high numerical aperture (NA), high aberration-corrected lens or tools equipped with complex illumination. A conventional patterning technique may also use complicated and expensive masks, which employ various phase shifters and complex optical proximity corrections (OPC).

### BRIEF DESCRIPTION OF DRAWINGS

FIG. 1A illustrates an interference lithography apparatus.

FIG. 1B illustrates an example of a diffraction grating with slits which allow light to pass through and be projected by a projection optical lithography system to radiate and form a patterned image of the grating on a photoresist on a substrate.

FIG. 2 illustrates a latent or real image of an interference pattern of spaces and lines produced by the lithography apparatuses of FIG. 1A or FIG. 1B.

FIG. 3A illustrates an example of a desired layout of lines with different widths on the photoresist formed by an interference lithography process and a second lithography process.

FIG. 3B illustrates (a) a latent pattern of continuous non-exposed lines of equal width and exposed spaces formed by an interference lithography process or optical projection lithography employing an alternative phase shifted mask and (b) features to be formed by a second lithography process.

FIG. 3C illustrates a layout after the latent pattern of non-exposed lines and exposed spaces of FIG. 2 has been altered by the second lithography process.

FIG. 3D illustrates axes of optical-proximity-corrected line features related to FIG. 3C.

FIGS. 4A-4H illustrate an example of a second lithography process to expose areas on a photoresist and subsequent processes of developing, etching and stripping.

FIG. 5 illustrates a composite optical lithography exposure system with a movable wafer stage.

FIG. 6 shows an optical lithographic implementation of the second patterning system.

FIG. 7 is a flow chart of the composite optical lithography patterning technique.

FIG. 8 shows a process for generating a layout of a mask for the second lithography process.

FIG. 9 shows an example of a design layout.

FIG. 10 shows an example of a remainder layout.

FIG. 11 shows a remainder layout after an expansion in a direction D.

### DETAILED DESCRIPTION

The present application relates to a composite optical lithography patterning technique, which may form smaller integrated circuit features compared to conventional lithography techniques. The composite patterning technique may provide a high density of integrated circuit features for a given area on a substrate.

The composite patterning technique may include two lithography processes. A first lithography process may use a radiation source and an interference lithography apparatus to form a pattern of alternating, continuous lines of substantially equal width and spaces on a photoresist. A second lithography process may use one or more non-interference lithography techniques, such as optical lithography, imprint lithography and electron-beam (e-beam) lithography, to break continuity of the patterned lines and form desired integrated circuit features.

The composite patterning technique may form patterns of lines with close but unequal width. Patterned lines of close but unequal width (e.g., within range of ±5-20% of average line width) may be desirable in integrated circuit (IC) manufacturing, for example, to pattern gates with slightly different widths. Gates with slightly different widths may optimize both speed and power performance of an integrated circuit.

In another embodiment, the first process may include a non-interference lithography technique, and the second process may include an interference lithography technique.

First Lithography Process

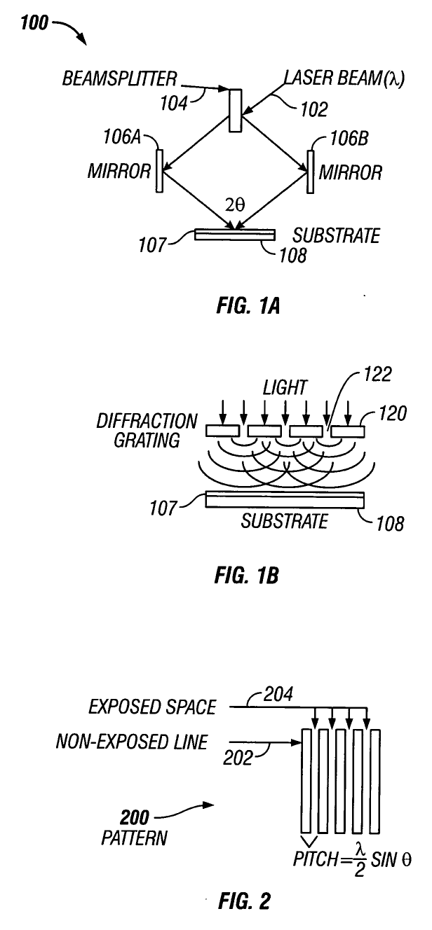

FIG. 1A illustrates an interference lithography apparatus 100 (also called interference exposure apparatus). The interference lithography apparatus 100 may include a beam splitter 104 and two mirrors 106A, 106B. The beam splitter 104 may receive radiation, such as a collimated and expanded laser beam 102, from a radiation source with a pre-determined exposure wavelength (λ). The beam splitter 104 may direct the radiation 102 to the mirrors 106A, 106B. The mirrors 106A, 106B may form an interference pattern 200 (FIG. 2) on a substrate 108 with a photosensitive media, such as a photoresist layer 107. Many interferometric lithography tool designs with various complexity and sophistication are available. Either a positive or a negative photoresist may be used with the processes described herein. θ may be an angle between a surface normal of the photoresist 107 and a beam of radiation incident on the photoresist 107.

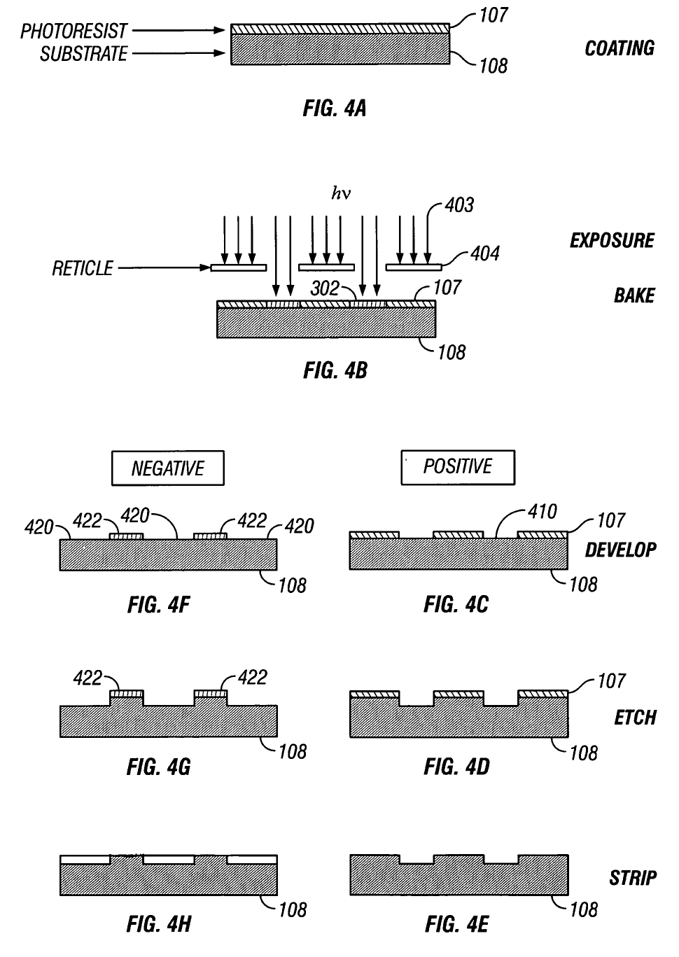

FIG. 2 illustrates a latent or real image of an interference pattern 200 of spaces 204 (exposed to light) and lines 202 (not exposed to light) produced by the interference lithography apparatus 100 of FIG. 1A. “Latent” refers to a pattern on the photoresist 107 which experienced a chemical reaction due to radiation but has not yet been developed in a solution to remove the exposed areas of the positive tone photoresist 107 (FIG. 4C described below). The lines 202 may have a substantially equal width. The spaces 204 may or may not have a width equal to the width of the lines 202.

“Pitch” is a sum of a line width and a space width in FIG. 2. As known to those of ordinary skill in optics, a “minimal pitch,” which can be resolved in air by a projection optical exposure apparatus with a pre-determined wavelength x and numerical aperture NA, may be expressed as:
pitch/2=(k₁(λ/nᵢ))/NA,
   where “NA” is the numerical aperture of a projection lens in the lithography tool, k₁ may be known as a Rayleigh's constant, and “nᵢ” is the refractive index of a media between the substrate 108 and the last element of the optical projection system, e.g., mirrors 106A, 106B. Optical projection systems currently in use for microlithography use air, which has nᵢ=1. Alternatively, nᵢ>1.4 for liquid immersion microlithographic systems. For nᵢ=1, the pitch may be expressed as:
   pitch/2=k₁λ/NA
   pitch=2k₁λ/NA

NA may be expressed as:
NA=n₀ sin θ.

NA may be equal to 1.

If k₁=0.25, and n₀ is about equal to one, pitch may expressed as:
pitch=2(0.25)λ/n₀ sin θ≅λ/2 sin θ

Other values of k₁ may be greater than 0.25.

The interference lithography apparatus 100 of FIG. 1A may achieve a “minimal pitch” (a minimal line width plus space width) expressed as:
minimal pitch≅λ/2

The lines 202 and spaces 204 may have a pitch P₁ approaching λ₁/2, where λ₁ is the radiation wavelength used in the interference lithography process. The wavelength λ₁ may equal to 193 nm, 157 nm or an extreme ultraviolet (EUV) wavelength, such as 11-15 nm. Larger pitches may be obtained by changing the angle θ of interfering beams in FIG. 1A.

Minimal feature size of an exposed space 204 or non-exposed line 202 may be equal to, less than or larger than exposure wavelength divided by four (θ/4).

Instead of the beam splitter 104, any light-splitting element may be used as part of an interference lithography system, such as a prism or diffraction grating, to produce a pattern 200 of alternating lines 202 and spaces 204 on the photoresist 107.

FIG. 1B illustrates an example of a diffraction grating 120 with slits 122 which allow light to pass through and (with the help of projection optics) to be focused on the photoresist 107 on the substrate 108. The diffraction grating 120 in conjunction with projection optics may produce the same interference pattern 200 (FIG. 2) as the beam splitter 104 and mirrors 106A, 106B of FIG. 1A.

Instead of the apparatuses in FIGS. 1A and 1B, the first lithography process may use an alternating phase shifted mask and optical projection lithography to form a pattern of lines and spaces at k₁ approaching 0.25.

The first lithography process (performed by interference lithography or optical projection lithography employing an alternating phase shifted mask constituting diffraction grating of minimal pitch resolvable by optical projection system) may define a width and/or length of all minimal critical features of a final pattern layout.

The size of the pattern 200 formed by interference lithography may be equal to a die, multiple dies or a whole wafer, e.g., a 300-mm wafer or even larger future generation wafer sizes. Interference lithography may have excellent dimensional control of an interference pattern 200 due to a large depth of focus.

Interference lithography may have a lower resolution limit and better dimensional control than lens-based lithography. Interference lithography may have a higher process margin than lens-based lithography because depth of focus for interference lithography may be hundreds or thousands of microns, in contrast to a fraction of a micron (e.g., 0.3 micron) depth of focus for some conventional lithography techniques. Depth of focus may be important in lithography since a photoresist may not be completely flat because (a) the photoresist is formed over one or more metal layers and dielectric layers or (b) semiconductor wafer itself might not be sufficiently flat.

An embodiment of interference lithography may not need a complicated illuminator, expensive lenses, projection and illumination optics or a complex mask, in contrast to other lithography techniques.

Second Lithography Process

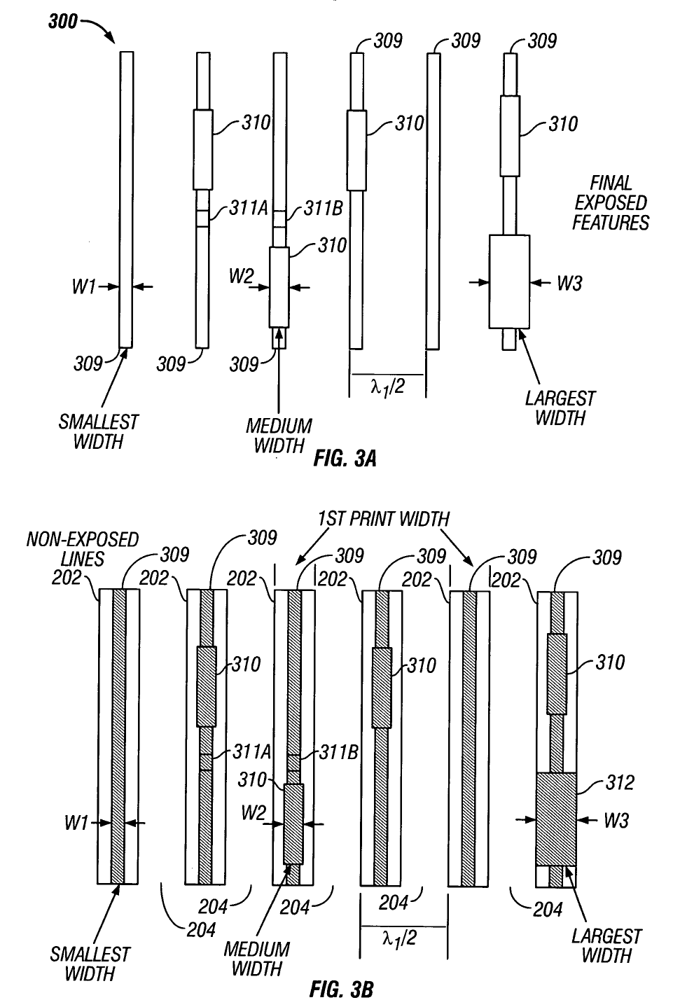

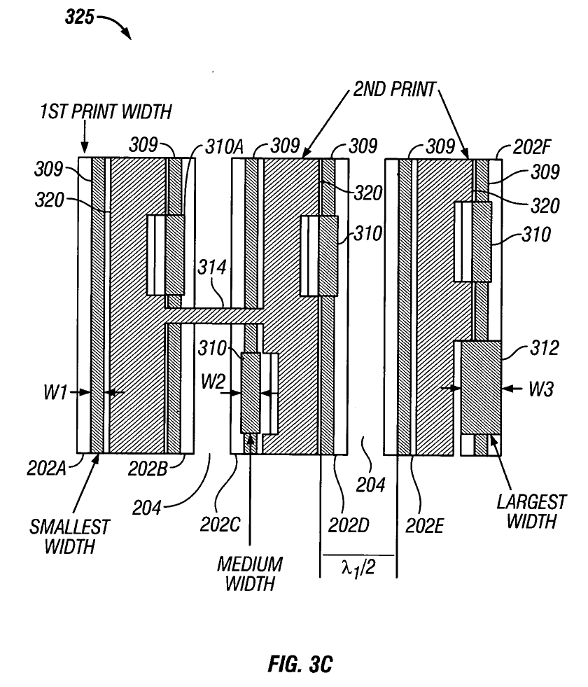

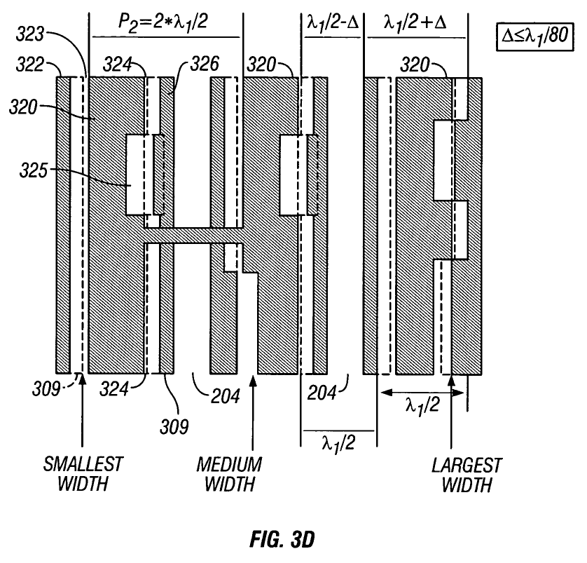

FIG. 3A illustrates an example of a desired layout 300 formed by the first lithography process described above and a second lithography process described below. The layout 300 includes light-exposed areas 204, 311A, 311B and non-exposed features 309, 310, 312 with different widths W₁, W₂ and W₃ on the photoresist 107 (FIG. 1A). The difference in layout and widths W₁, W₂, W₃ in FIG. 3A may be exaggerated for illustrative purposes. The pitch P₁ between two consecutive features 309 may be about λ₁/2, where λ₁ is the radiation wavelength of the interference lithography described above. The wavelength λ₁ may equal to 193 nm, 157 nm, ultraviolet, deep ultraviolet, vacuum ultraviolet or an extreme ultraviolet (EUV) wavelength, such as 11-15 nm.

FIG. 3B illustrates (a) a pattern of continuous non-exposed lines 202 and exposed spaces 204 formed by the first lithography process described above, and (b) features 309, 310, 311, 312 that will be formed by a second lithography process. The lines 202 and spaces 204 may have a pitch P₁ approaching λ₁/2. Each line 202 formed by the first (e.g., interference) lithography process has a width W₃, which may be the width of the widest desired feature 312 in the circuit layout 300 (FIG. 3A) after the second lithography process. The width W₃ may be larger than widths W₁ and W₂ of other features 309, 310 to be formed by the second lithography process. Line width W₁ may be the smallest width for a desired feature 309 to be formed. Line width W₂ may be a medium width for a desired feature 310 to be formed.

FIG. 3C illustrates a layout 325 after the latent image pattern 200 of non-exposed lines 202 and exposed spaces 204 formed by the first lithography process has been altered by the second lithography process. The second lithography process may include one or more non-interference lithography techniques, such as a conventional lithography technique, such as optical lithography, imprint lithography and electron-beam lithography or optical or e-beam maskless lithography. The second lithography process may use ultraviolet, deep ultraviolet, vacuum ultraviolet or extreme ultraviolet (EUV) lithography.

In FIG. 3C, the second lithography process may expose areas 320 on the photoresist. The second lithography process may use an image on a mask (described further below) with (a) transparent areas to expose areas 320 and (b) opaque (non-transparent) areas, which may use a material such as chrome. The clear transmissive areas of the mask will expose areas 320 in FIG. 3C, which will expose portions of the previously non-exposed (latent image) lines 202. This breaks continuity of the non-exposed lines 202. Thus, the exposed areas 320 remove portions or adjust widths of the latent lines 202A, 202B, 202C, 202D. Jagged features of the mask used in the second lithography process will preserve W₃ wherever needed (e.g., for feature 312) and radiate additional light elsewhere on the photoresist to narrow lines 202 from W₃ to desired widths W₁ and W₂ with optical proximity correction (OPC) (described below). In addition, the second lithography process may expose area 314 in FIG. 3C to form features 311A, 311B in FIG. 3A.

Alternatively, if the second lithography process uses EUV wavelengths, there may be no transparent materials at that wavelength. Elements of an EUV lithography system, including the mask to be used, may be reflective. The clear (transmissive) areas on a non-EUV mask will be reflective areas on a EUV mask, and opaque (chrome) areas on a non-EUV mask will be absorptive areas on an EUV mask.

As shown in FIG. 3C, the areas 320 exposed by the second lithography process do not fully form the desired features 309, 310, 312 of the functional electrical circuit layout 300 in FIG. 3A since there are thin gaps between the features 309, 310, 312 and the exposed areas 320. To form features 309, 310, 312 with desired widths W₁ and W₂, the second lithography process may use optical proximity correction on a mask to adjust latent image lines 202 (formed by first step lithography process) with a width W3 to desired line widths W₁ and W₂ (identified by electrical design lines). For diffraction limited lithography employed with the second patterning step, light intensity may not be a step function between edges of transparent and non-transparent/opaque areas of the mask used in the second lithography process. Manipulation of the location of edges of the opaque area on the mask may result in additional exposure of the latent image and consequent line width change of the latent image as a result of a second patterning step. Such opaque image manipulation constitutes optical proximity correction (OPC). OPC is used to compute, manipulate, and adjust the extension of edges of the opaque/non-transparent (e.g., chrome) areas of the mask. The mask may show sizing derived by OPC to induce changes in the latent pattern and fully form the features 309, 310, 312 with multiple line widths W₁, W₂, W₃.

The second lithography process may use a mask or reticle (terms are used interchangeably in the art of microlithography) (FIGS. 4B and 8-11). The pattern layout of the second lithography process' exposure mask (or maskless patterning tool database that contains OPC corrections) may be a Boolean difference between (a) a desired final pattern layout 300 (FIG. 3A), and (b) the pattern 200 (FIG. 2) formed by the first lithography process. The layout 300 may be sized to accommodate mask making manufacturing dimensional requirements and overlay controls between first and second lithography processes. If the second lithography process uses a transmissive exposure mask, the mask layout (or its corresponding database for maskless patterning) will have (a) transparent portions to allow radiation of areas 320, 314 in FIG. 3C and (b) an opaque mask background to block radiation outside areas 320, 314. Thus, the spaces 204 and areas 320, 314 in FIG. 3C are exposed to radiation during the first and second lithography processes, respectively.

The second lithography process may result in a small displacement Δ (e.g., several nanometers for advanced lithography) of the axes of OPC-corrected line features shown in FIG. 3D. A centered longitudinal axis of each line 202 in FIGS. 2 and 3B may shift slightly to the left or the right depending on whether OPC is applied to the right or the left of the line 202. Provisions for such displacement can be accommodated by increasing corresponding design tolerances by an equally small amount. With OPC, areas 322, 323, 324, 325 and 326 are exposed to light to form the desired features 309, 310 as shown in FIG. 3A. Δ may be less than or equal to λ₁/80.

The pitch P₂ of the second lithography process may be about 1.5(λ₁/2) (or 2(λ₁/2)) or larger, which is one and a half (or twice) the size of the pitch P₁ (λ₁/2) of the interference lithography process described above or larger.

FIGS. 4A-4H illustrate an example of a second lithography process to expose areas 320 (FIG. 3C) on the photoresist 107 and subsequent processes of developing, etching and stripping. A photoresist 107 may be formed (e.g., coated) on a substrate 108 in FIG. 4A. A latent or real interference pattern 200 (FIG. 2) may be formed on the photoresist 107 by the interference lithography apparatus 100 of FIG. 1A. A second lithography tool (second lithography process) may transmit light 403 through a patterned mask or reticle 404 to expose desired areas 302 of the photoresist 107 in FIG. 4B. The light 403 may start a reaction in the exposed areas 320. The light 403 may be 248 nm, 194 nm, 157 nm or extreme ultraviolet (EUV) radiation, for example, with a wavelength of about 11-15 nanometers (nm).

The photoresist 107 and substrate 108 may be removed from the lithography tool and baked in a temperature-controlled environment. Radiation exposure and baking may change the solubility of the exposed areas 320 and spaces 204 (FIG. 2) compared to unexposed areas of the photoresist 107. The photoresist 107 may be “developed,” i.e., put in a developer and subjected to an aqueous (H₂O) based solution, to remove exposed areas 320 and spaces 204 of the photoresist 107 in FIG. 4C to form a desired pattern in the resist. If a “positive” photoresist is used, exposed areas 320 and spaces 204 may be removed by the solution. Portions 410 of the substrate 108 which are not protected by the remaining photoresist 107 may be etched in FIG. 4D to form desired circuit features. The remaining photoresist 107 may be stripped in FIG. 4E.

The second lithography process may use a maskless patterning technique.

Combining an interference lithography technique and a non-interference technique may provide high IC pattern density scaling (patterning at k₁=0.25 for any available wavelength).

Interference lithography, which patterns minimal pitch features, may extend 193-nm immersion lithography to 66-nm pitch and may extend an EUV interference tool capability down to 6.7-nm pitch.

Interference lithography may have an all-reflective design, e.g., Lloyds' mirror interferometric lithographic system, which may enable system design with available wavelengths between 157 nm and 13.4 nm, such as a neon discharge source (about 74-nm wavelength) and a helium discharge source (58.4-nm wavelength) with corresponding minimal pitches of 37 nm and 30 nm, respectively.

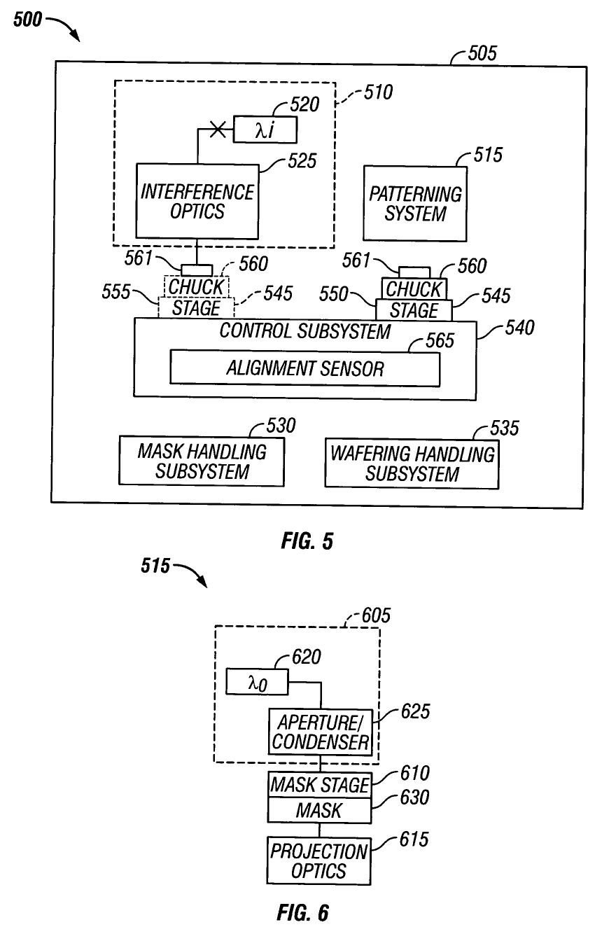

FIG. 5 illustrates a composite optical lithography system 500 with a movable wafer stage 545. The composite optical lithography system 500 may include an environmental enclosure 505, such as a clean room or other location suitable for printing features on substrates. The enclosure 505 encloses a first patterning system 510 (e.g., an interference lithography system) and a second (non-interference) patterning system 515. The first patterning system 510 may include a collimated radiation source 520 and interference optics 525 to provide interferometric patterning on a photoresist.

The second patterning system 515 may use one of several techniques to pattern a photoresist. For example, the second patterning system 515 may be an e-beam projection system, an imprint printing system, or an optical lithography system. Alternatively, the second patterning system 515 may be a maskless module, such as an electron beam direct write module, an ion beam direct write module, or an optical direct write module.

The two systems 510, 515 may share a common mask handling subsystem 530, a common wafer handling subsystem 535, a common control subsystem 540, and a common stage 545. The mask handling subsystem 530 may position a mask in the system 500. The wafer handling subsystem 535 may position a wafer 561 in the system 500. The control subsystem 540 may regulate one or more properties or devices of system 500 over time. For example, the control subsystem 540 may regulate the position, alignment or operation of a device in system 500. The control subsystem 540 may also regulate a radiation dose, focus, temperature or other environmental qualities within environmental enclosure 505.

The control subsystem 540 may also translate the stage 545 between a first exposure stage position 555 and a second exposure stage position 550. The stage 545 includes a wafer chuck 560 for gripping a wafer 561. At the first position 555, the stage 545 and the chuck 560 may present a gripped wafer 561 to the first patterning system 510 for interferometric patterning. At the second position 550, the stage 545 and the chuck 560 may present the gripped wafer 561 to the second patterning system 515 for patterning.

To ensure the proper positioning of a wafer 561 by the chuck 560 and the stage 545, the control subsystem 540 may include an alignment sensor 565. The alignment sensor 565 may transduce and control the position of the wafer 561 (e.g., using wafer alignment marks) to align a pattern formed by the second patterning system 515 with a pattern formed by the first patterning system 510. Such positioning may be used when introducing irregularity into a repeating array of interferometric features, as discussed above.

FIG. 6 shows an optical lithographic implementation of the second patterning system 515. In particular, the second patterning system 515 may be a step-and-repeat projection system. Such a patterning system 515 may include an illuminator 605, a mask stage 610, a mask 630 and projection optics 615. The illuminator 605 may include a radiation source 620 and an aperture/condenser 625. The radiation source 620 may be the same as radiation source 520 in FIG. 5. Alternatively, the radiation source 620 may be a separate device. The radiation source 620 may emit radiation at the same or at a different wavelength as the radiation source 520.

The aperture/condenser 625 may include one or more devices for collecting, collimating, filtering, and focusing the emitted radiation from the radiation source 520 to increase the uniformity of illumination upon mask stage 610. The mask stage 610 may support a mask 630 in the illumination path. The projection optics 615 may reduce image size. The projection optics 615 may include a filtering projection lens. As the stage 545 translates a gripped wafer 561 for exposure by the illuminator 605 through mask stage 610 and projection optics 615, the alignment sensor 565 may ensure that the exposures are aligned with a repeating array 200 of interferometric features to introduce irregularity into the repeating array 200.

Alignment

An existing alignment sensor (not shown) on the interference lithography apparatus 100 may align the pattern 200 (FIG. 2) produced by the first lithography process to a previous layer pattern formed by other processes. An existing alignment sensor may be above a wafer and be adapted to sense a mark on the wafer.

Alignment of the second lithography process to the first lithography process may be achieved by either indirect alignment (second lithography process aligns to previous layer pattern by means of existing alignment sensors) or direct alignment (second lithography process aligns to first lithography process pattern 200 directly) by means of a latent image alignment sensor.

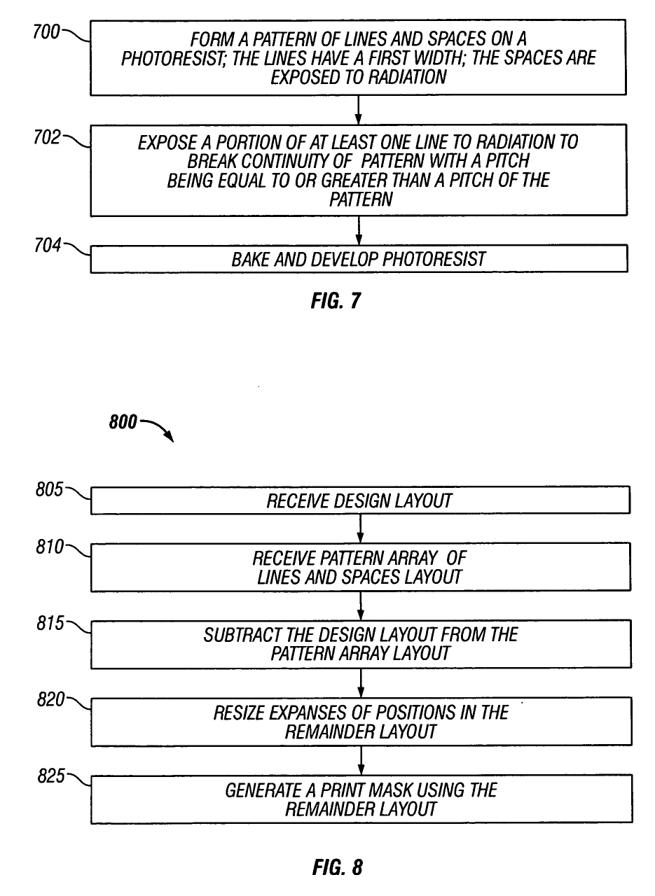

FIG. 7 is a flow chart of the composite optical lithography patterning technique. Interference lithography exposure on a photoresist at 700 may be followed by a second lithography exposure applied to the same photoresist at 702. The photoresist may be baked, and soluble portions of the photoresist may be developed at 704 if the photoresist is sensitive to both interference lithography and the second lithography exposure wavelength(s).

FIG. 8 shows a process 800 for generating a layout of a mask for the second lithography process described above. The process 800 may be performed by one or more actors (such as a device manufacturer, a mask manufacturer, or a foundry) acting alone or in concert. The process 800 may also be performed in whole or in part by a data processing device executing a set of machine-readable instructions.

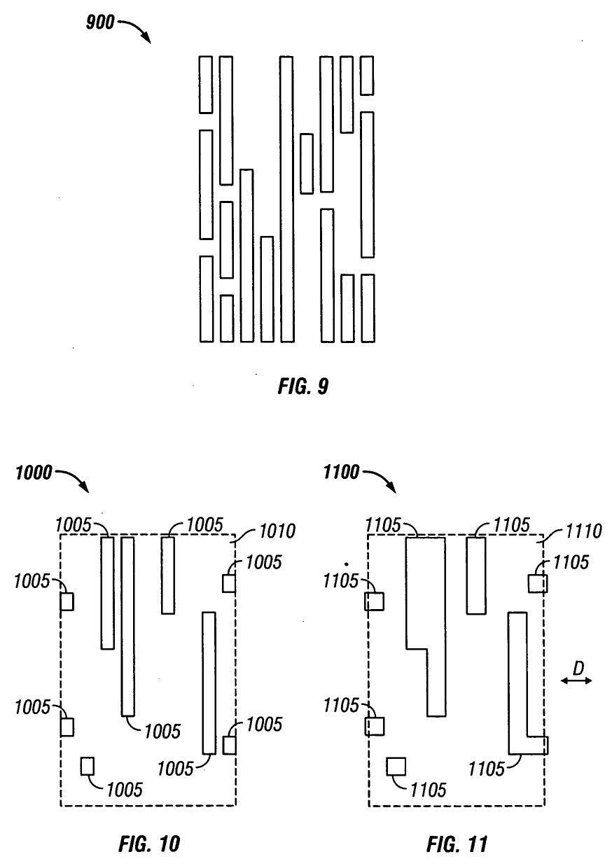

The actor performing the process 800 receives a design layout at 805. The design layout is an intended physical design of a layout piece or substrate after processing. FIGS. 3A and 9 show examples of such design layouts 300, 900. The design layout 300, 900 may be received in a machine-readable form. The physical design of the layout 300, 900 may include a collection of trenches and lands between the trenches. The trenches and lands may be linear and parallel. The trenches and lands need not repeat regularly across the entire layout piece. For example, the continuity of one or both of trenches and lands may be cut at arbitrary positions in the layout 300, 900.

Returning to FIG. 8, the actor performing the process 800 may also receive a pattern array layout 200 of alternating, parallel lines 202 and spaces 204 (FIG. 2) at 810. The pattern array layout 200 may be formed on a photoresist 107 by interferometric lithography techniques, i.e., interference of radiation. The pattern array layout 200 may be received in a machine-readable form.

Returning to FIG. 8, the actor may subtract the design layout 900 (FIG. 9) from the pattern array layout 200 (FIG. 2) at 815. The subtraction of the design layout 900 from the pattern array layout 200 may include aligning trenches in the design layout 900 with either lines or spaces in the pattern array layout 200 and determining positions where irregularity in the design layout 900 prevents complete overlap with the pattern array layout 200.

FIG. 10 shows an example of a remainder layout 1000 that indicates positions where the design layout 900 does not completely overlap with the pattern array layout 200 (FIG. 2). The remainders layout 1000 may be in machine-readable form. The subtraction may be Boolean because positions in the remainder layout 1000 may have only one of two possible states. In particular, the remainder layout 1000 includes expanses of first positions 1005 with a “not overlapped” state and a contiguous expanse of second positions 1010 with an “overlapped” state.

Returning to FIG. 8, the actor may resize expanses of positions in the remainder layout 1000 at 820. The resizing of the remainder layout 1000 may result in a changed machine-readable remainder layout 1100 in FIG. 11. FIG. 11 shows a remainder layout 1100 after such an expansion in a direction D. When the pattern array is an array 200 of parallel lines 202 and spaces 204, the size of expanses 1105 with a present state may be increased in the direction perpendicular to the lines 202 and spaces 204. Some expanses 1105 may merge.

Returning to FIG. 8, the actor may generate a print mask using the remainder layout 1000 in FIG. 10 at 825. The print mask may be generated using the resized remainder layout 1100 of FIG. 11 to create arbitrarily shaped features for introducing irregularity into a repeating array, such as the pattern array 200 (FIG. 2). The generation of the print mask may include generating a machine-readable description of the print mask. The generation of the print mask may also include tangibly embodying the print mask in a mask substrate.

A number of embodiments have been described. Nevertheless, it will be understood that various modifications may be made without departing from the spirit and scope of the application. Accordingly, other embodiments are within the scope of the following claims.

1. A system comprising:
a first apparatus to radiate an interference pattern of lines and spaces on a photoresist, the lines having a substantially equal first width, the spaces being exposed to radiation; and
a second apparatus to radiate selected areas of the photoresist, the selected areas exposing portions of the lines to radiation, wherein a pitch of the selected areas exposed by the second subsystem is at least one and a half times a pitch of the interference pattern.

2. The system of claim 1, wherein a second width of a feature formed by the second apparatus is equal to the first width of a line of the interference pattern.

3. The system of claim 1, wherein a second width of a feature formed by the second apparatus is less than the first width of a line of the interference pattern.

4. The system of claim 1, wherein the second apparatus uses optical proximity correction (OPC) on a mask to adjust feature widths.

5. The system of claim 1, wherein the first apparatus comprises a beamsplitter.

6. The system of claim 1, wherein the first apparatus comprises a diffraction grating.

7. The system of claim 1, wherein the second apparatus comprises a mask-based optical lithography tool.

8. The system of claim 1, wherein the second apparatus comprises an electron beam lithography tool.

9. The system of claim 1, wherein the second apparatus comprises a maskless optical lithography tool with a database.

10. A method comprising:
forming an interference pattern of non-exposed lines and exposed spaces on a photoresist, the lines having a first width;
exposing a portion of at least one line to radiation to form features with a second width, the second width being less than the first width, wherein a pitch of the features is at least one and a half times a pitch of the interference pattern.

11. The method of claim 10, wherein a pitch of the features is greater than one and a half times a pitch of the interference pattern.

12. The method of claim 10, wherein the radiation has a pre-determined wavelength, the interference pattern approaching a pitch equal to the wavelength divided by two.

13. The method of claim 10, further comprising generating a print mask from Boolean subtraction of (a) a final design layout for a given layer from (b) the interference pattern.

14. An system comprising:
a first patterning system to produce a first exposed array of lines on a photosensitive media; and
a second patterning system to produce a second exposure, the second exposure reducing regularity of the array formed by the interference exposure apparatus, the second exposure forming features with a second width, the second width being less than a first width of the lines, wherein a pitch of the features is at least one and a half times a pitch of the exposed array of lines.

15. The system of claim 14, further comprising an alignment sensor to align the second exposure produced by the second patterning system to the first exposed array formed by the first patterning system.

16. The system of claim 14, further comprising a common control system to enable the first patterning system and second patterning system to provide first and second exposures to the photosensitive media.

17. The system of claim 14, where the first patterning system comprises an interference exposure apparatus, and the second patterning system comprises a projection optical lithography system, the projection optical lithography system comprising projection optics, a wafer stage, and a mask to reduce regularity in the array created by the interference exposure apparatus.

18. The system of claim 14, where the first patterning system comprises an interference exposure apparatus, and the second patterning system comprises an imprint system that comprises projection optics, a wafer stage, and a mask to reduce regularity in the array created by the interference exposure apparatus.

19. The system of claim 14, where the first patterning system comprises an interference exposure apparatus, and the second patterning system comprises an electron projection system that comprises projection optics, a wafer stage, and a mask to reduce regularity in the array created by the interference exposure apparatus.

20. The system of claim 14, where the first patterning system comprises an interference exposure apparatus, and the second patterning system comprises a maskless module to reduce regularity in the array created by the interference exposure apparatus, projection optics and a wafer stage.

21. The system of claim 20, wherein the maskless module comprises an optical direct write module.

22. The system of claim 20, wherein the maskless module comprises an electron beam direct write module.

23. The system of claim 20, wherein the maskless module comprises an ion beam direct write module.

24. The system of claim 14, where the first patterning system comprises an interference exposure apparatus, and the second patterning system comprises an X-ray proximity projection system that contains mask necessary to reduce regularity in a pattern created by the interference exposure apparatus, projection optics and a wafer stage.
